(19) United States
(12) Patent Application Publication
(10) Pub. No.: US 2021/0158467 A1
(43) Pub. Date: May 27, 2021

(54) SYSTEMS AND METHODS FOR AUTOMATIC DELIVERY WORKER ASSIGNMENT

(71) Applicant: COUPANG CORP., Seoul (KR)

(72) Inventors: Hyunseok LEE, Seoul (KR); Keunwoo SUNG, Seoul (KR); Jae Bong IM, Seoul (KR)

(73) Assignee: COUPANG, CORP.

(21) Appl. No.: 16/697,027

(22) Filed: Nov. 26, 2019

(51) Int. Cl. G06Q 50/28; G06Q 10/06

(52) U.S. Cl. CPC G06Q 50/28; G06Q 10/063112; G06Q 10/06393

(57) ABSTRACT

A computerized system for automatic delivery worker assignment. The computerized system may include at least one non-transitory storage medium comprising instructions that, when executed by the at least one processor, cause the at least one processor to perform steps. The steps may include receiving an actual number of units sold during a first time period; receiving an indication of a number of parcels received during a first period of time at a first camp; receive a unit per parcel rate associated with the first camp; generating, based on the received actual number of units, the number of parcels received, and the unit per parcel rate, a forecast calculation for the first camp; determining, based on the forecast calculation, a number of routes; receiving an indication of an available number of delivery workers; and assigning a plurality of the delivery workers to the determined routes.

### TECHNICAL FIELD

The present disclosure generally relates to computerized systems and methods for automatic delivery worker assignment. In particular, embodiments of the present disclosure relate to inventive and unconventional systems for automatically generating a forecast calculation, determining a number of delivery routes based on the forecast calculation, and automatically assigning a plurality of delivery workers to the determined delivery routes for delivering packages.

### BACKGROUND

Numerous computerized inventory management systems and delivery centers exist. These systems and centers are designed to enable efficient distribution of goods in an established delivery area and to utilize available resources for delivering these goods to consumers, for example, at local shipping centers. Traditionally, each delivery center may divide its established delivery area into separate regions, and then these systems may direct delivery workers to deliver the goods to one or more of the regions.

Typically, however, each region is only covered by a single delivery worker, who may be unable to keep up with a region's delivery demands. Further, conventional systems are unable to dynamically adjust regional assignment of delivery workers. Moreover, conventional systems are often not able to flexibly cope with a dynamic or changing delivery or sales forecast. Nor are they equipped to analyze a delivery vehicle's load limit or consider a delivery worker's delivery efficiency or skill.

Even further, numerous computerized inventory management systems include one or more administrators in charge of manually assigning delivery workers to deliver packages, which may add to an increase in delivery time and may result in delivery inefficiencies. Such administrator-based systems often times fail to accurately account for the required number of packages or parcels that need to be delivered.

Therefore, what is needed is a system that is capable of dynamically determining an optimum forecast calculation for automatic delivery worker assignment and delivery. Further, what is needed is a digital delivery solution that can quickly and flexibly handle unpredictable changes based on changes in sale forecasts and available delivery men resources. Finally, what is needed are improved methods and systems for re-calculating delivery forecasts in real-time so as to efficiently and automatically facilitate delivery worker resources to accommodate geographic and cyclical changes in sale forecasts.

### SUMMARY

One aspect of the present disclosure is directed to a computerized system for automatic delivery worker assignment. The computerized system may include at least one non-transitory storage medium comprising instructions that, when executed by the at least one processor, cause the at least one processor to perform steps. The steps may include receiving an actual number of units sold during a first time period; receiving an indication of a number of parcels received during a first period of time at a first camp; receive a unit per parcel rate associated with the first camp; generating, based on the received actual number of units, the number of parcels received, and the unit per parcel rate, a forecast calculation for the first camp; determining, based on the forecast calculation, a number of routes; receiving an indication of an available number of delivery workers; and assigning a plurality of the delivery workers to the determined routes.

Another aspect of the present disclosure is directed to a method for automatic delivery worker assignment. The method may perform operations including receiving an actual number of units sold during a first time period; receiving an indication of a number of parcels received during a first period of time at a first camp; receive a unit per parcel rate associated with the first camp; generating, based on the received actual number of units, the number of parcels received, and the unit per parcel rate, a forecast calculation for the first camp; determining, based on the forecast calculation, a number of routes; receiving an indication of an available number of delivery workers; and assigning a plurality of the delivery workers to the determined routes.

Yet another aspect of the present disclosure is directed to a system. The system may include a memory storing instructions and at least one processor configured to execute the instructions to perform operations. The operations may include receiving an actual number of units sold during first and second time periods; receiving an indication of a first number of parcels received during a first period of time at a first camp; receiving an indication of a second number of parcels received during a second period of time at a second camp; receiving a first unit per parcel rate associated with the first camp and a second unit per parcel rate associated with the second camp; generating, based on the received actual number of units, the first and the second number of parcels received, and the first and second unit per parcel rate, a first forecast calculation for the first camp and a second forecast calculation for the second camp, wherein the first forecast calculation is different from the second forecast calculation; determining, based on the first forecast calculation, a first number of routes; determining, based on the second forecast calculation, a second number of routes; receiving an indication of an available number of delivery workers; and assigning a plurality of the delivery workers to the first and second determined routes.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of a visualization of line graphs representative of forecast calculations for a plurality of units sold, consistent with the disclosed embodiments.

FIG. 4 is a diagrammatic illustration of delivery routes for a camp, consistent with the disclosed embodiments.

FIG. 5 is a diagrammatic illustration of delivery route across an exemplary geographic delivery area, consistent with the disclosed embodiments.

FIG. 6 is a flow chart illustrating an exemplary process for automatic delivery worker assignment, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for automatic delivery worker assignment including automatically determining an optimum forecast calculation for delivery of a required number of parcels in a particular delivery area.

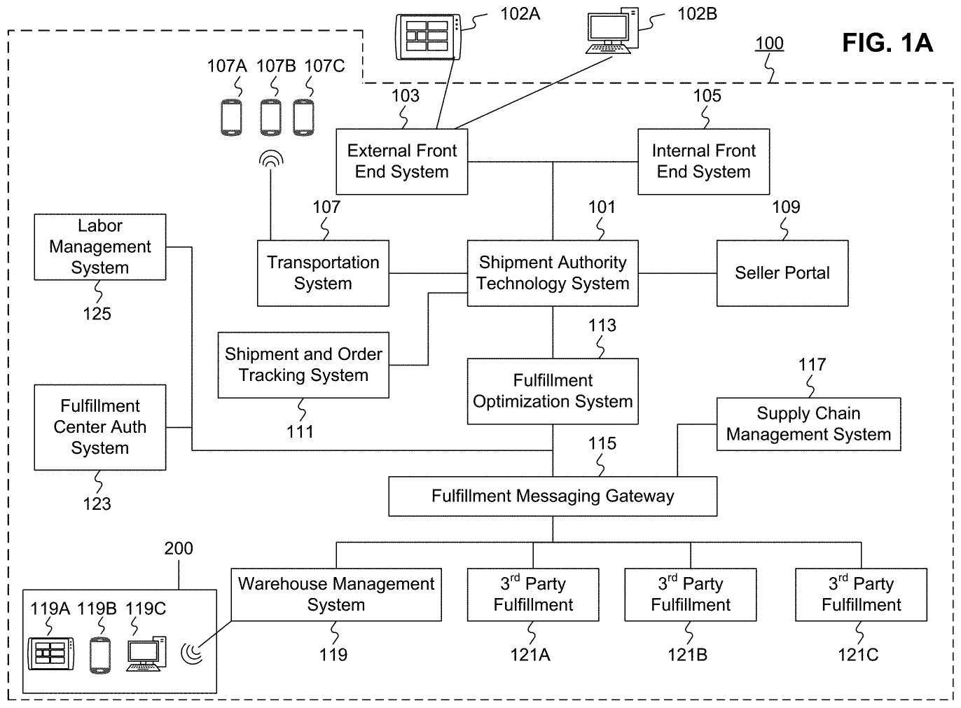

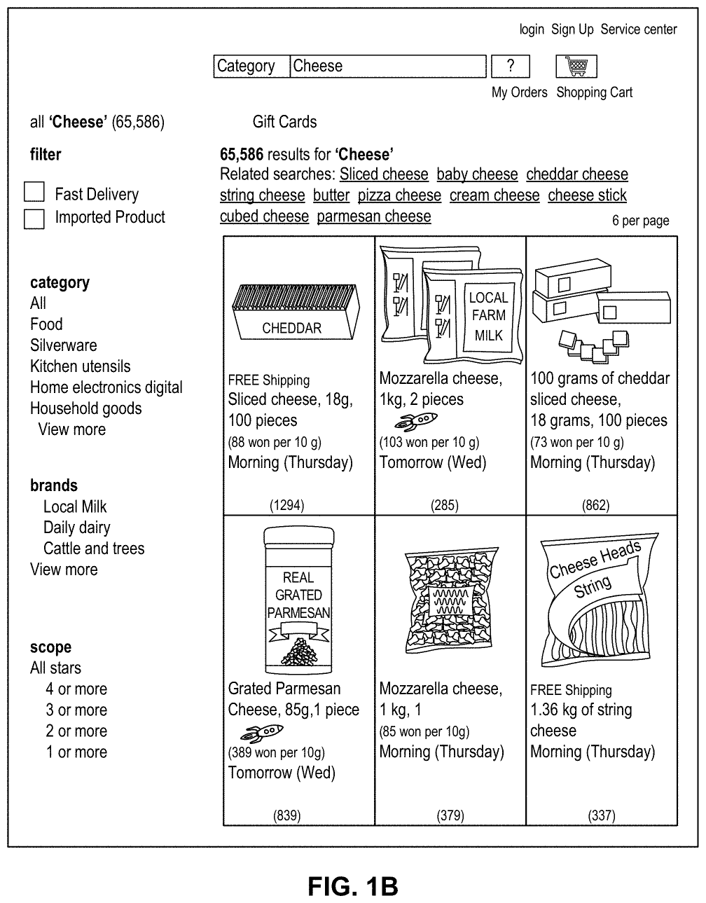

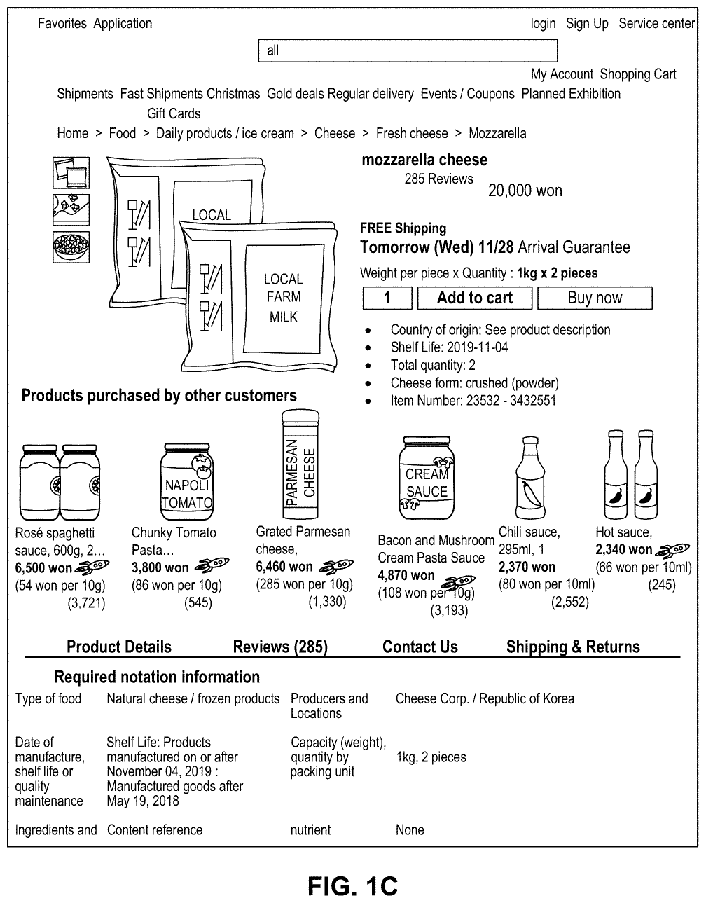

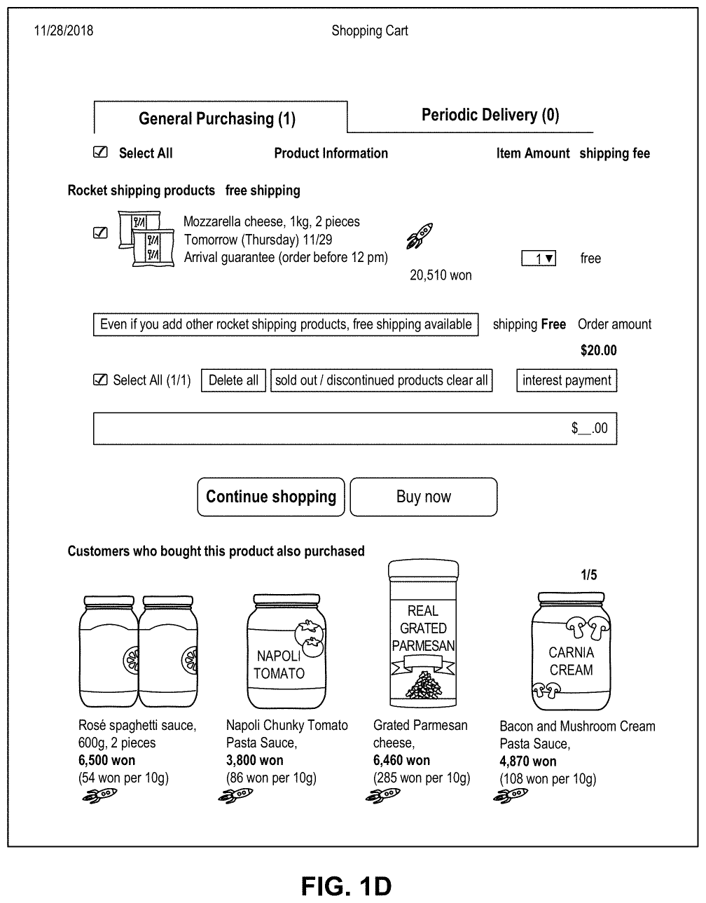

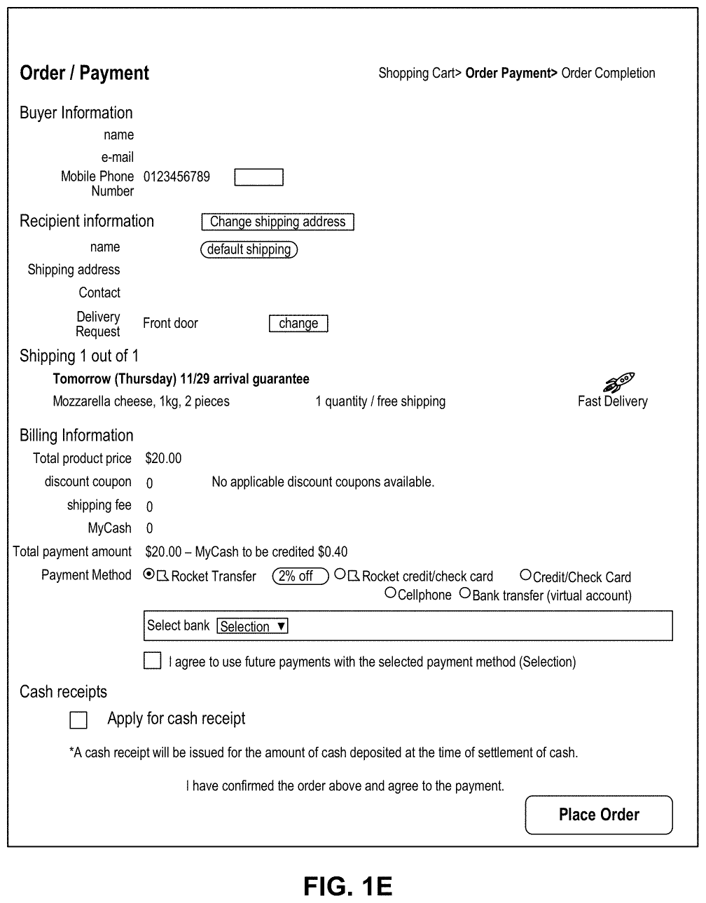

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

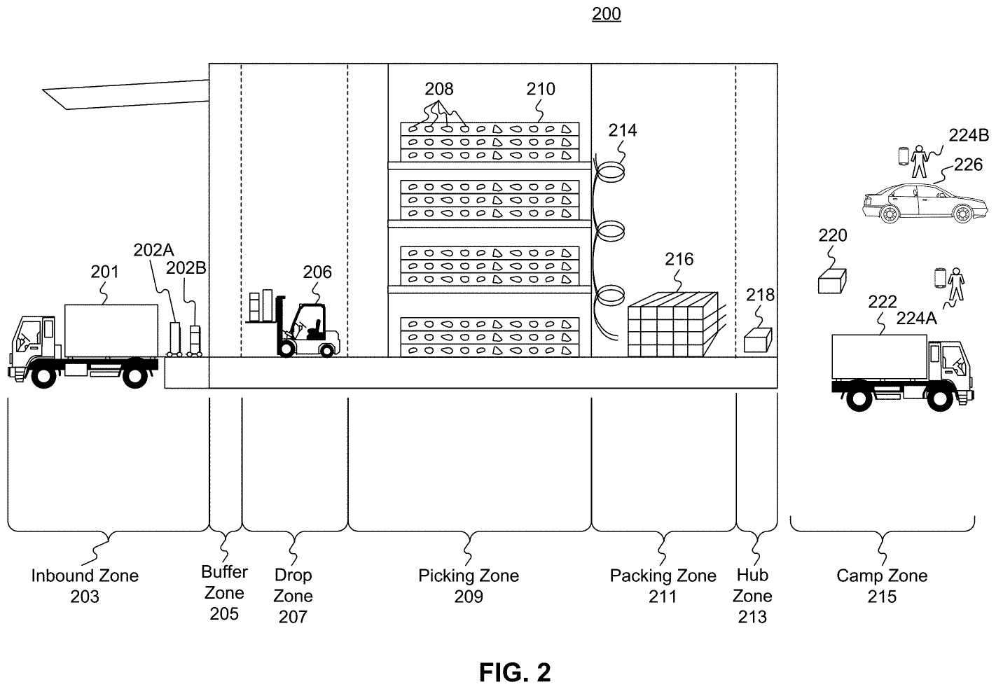

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

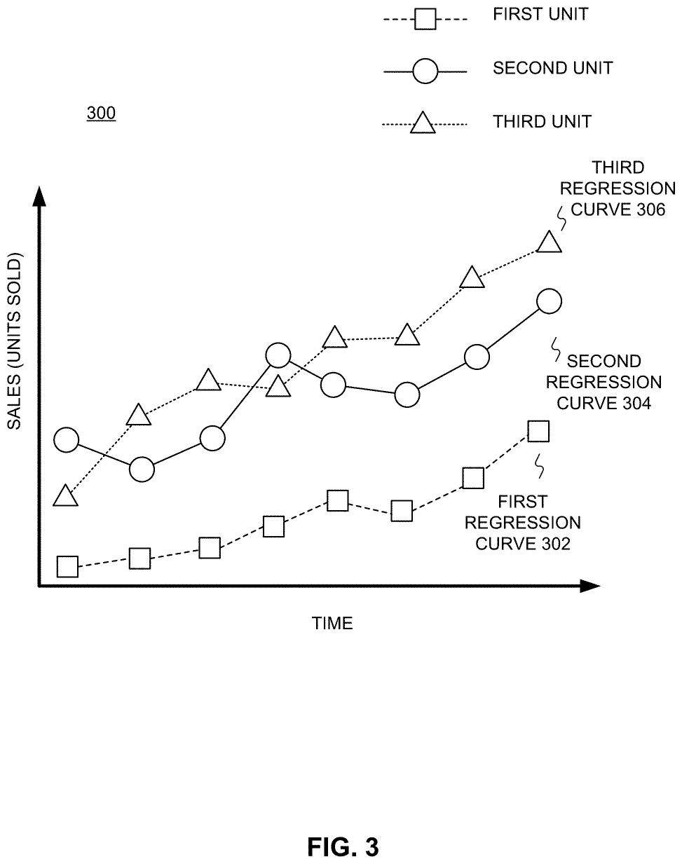

FIG. 3 is a diagrammatic illustration of a visualization of line graphs representative of forecast calculations for a plurality of units sold. While a visualization of line graphs is shown in FIG. 3, forecast calculation data may be stored and displayed in other ways. For example, forecast calculation data may be stored in a database by shipment authority technology system (SAT) 101, transportation system 107, shipment and order tracking (SOT) system 111, supply chain management system (SCM) 117, and/or labor management system (LMS) 125 and may be retrieved for display on devices 119A-119C and/or devices 107A-107C. Forecast calculation data may be displayed in a Microsoft Excel spreadsheet or in other software applications for display in a graphical user interface (GUI) presented on devices 119A-119C and/or devices 107A-107C. While a visualization of line graphs representative of forecast calculations for a plurality of units sold is shown in FIG. 3, other visualizations for other data types may be contemplated. For example, a visualization of bar or pie graphs for a plurality of stock keeping units (SKUs) may also be contemplated as consistent with this disclosure.

As shown in FIG. 3, shipment authority technology system (SAT) 101, transportation system 107, shipment and order tracking (SOT) system 111, supply chain management system (SCM) 117, and/or labor management system (LMS) 125 may receive an actual number of units sold during a plurality of different time periods. As shown in FIG. 3, first, second, and third units are plotted in line graphs along X and Y axes. The X-axis is representative of a discrete time period and the Y-axis is representative of sales (or number of units sold). As shown in FIG. 3, FIG. 3 displays a first regression curve 302, second regression curve 304, and a third regression curve 306. First regression curve 302, second regression curve 304, and third regression curve 306 constitute rolling averages of forecast quantities of units sold for a particular camp based on a generated forecast calculation.

Consistent with this disclosure, shipment authority technology system (SAT) 101, transportation system 107, shipment and order tracking (SOT) system 111, supply chain management system (SCM) 117, and/or labor management system (LMS) 125 may receive an indication of a number of parcels received during a first period of time at a first camp, subsequently receive a unit per parcel rate associated with the first camp, and may generate, based on the received actual number of units, the number of parcels received, and the unit per parcel rate, a forecast calculation for the first camp. As shown in FIG. 3, the forecast calculation may be plotted as any of line graphs 302, 304, and 306 for first, second, and third units respectively. As shown in FIG. 3, the forecast calculation tends to increase over time in linear fashion. However, forecast calculations for units sold may not necessarily be linear in fashion and may change based on variations in unit per parcel rate and received actual number of units.

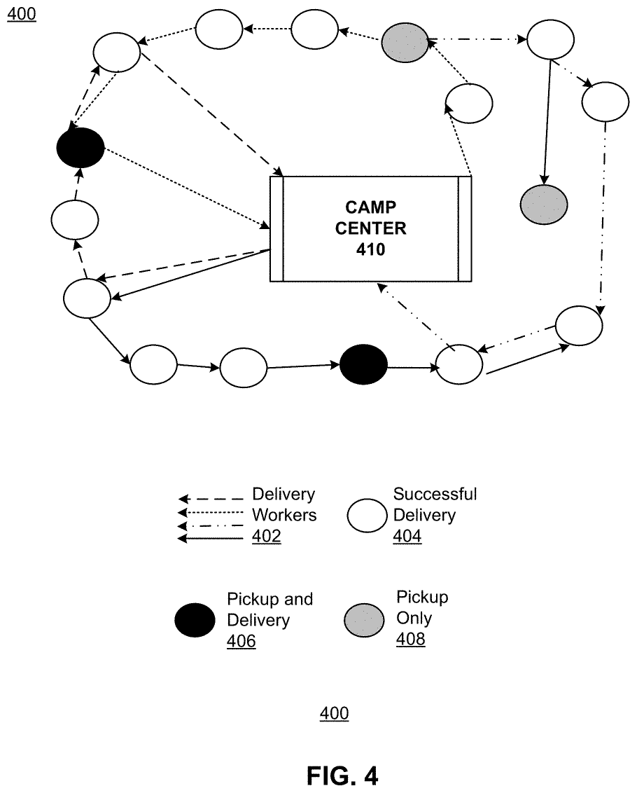

FIG. 4 is a diagrammatic illustration of delivery routes for a camp, consistent with the disclosed embodiments. As shown in FIG. 4, delivery workers 402 may make pickups and deliveries at one or more locations in proximity to a camp central location 410. As shown in FIG. 4, delivery workers 402 may make successful deliveries 404 at particular locations, and at other locations 406 may make both pickups and deliveries. Further, at select locations 408, delivery workers may make pickups only. As shown in FIG. 4, delivery workers 402 may make deliveries in any pattern, order or fashion, including, for example, hub-and-spoke fashion. Additionally, delivery workers 402 may make deliveries in a circumferential fashion as shown in FIG. 4, though other arrangements are possible (including non-circular routes, routes defined by a transportation network such as roads, or other routes). Consistent with this disclosure, shipment authority technology system (SAT) 101, transportation system 107, shipment and order tracking (SOT) system 111, supply chain management system (SCM) 117, and/or labor management system (LMS) 125 may determine based on the forecast calculation, a number of routes; receive an indication of an available number of delivery workers and may assign a plurality of the delivery workers 402 to the determined routes. As shown in FIG. 4, both solid and dashed lines represent delivery routes available for a plurality of different delivery workers 402 based on a forecast calculation. Delivery workers 402 may be supplemented with delivery workers 402 from other camps (or by adding flex or non-fixed schedule workers). Additional delivery workers 402 may be added to the existing camp center 410.

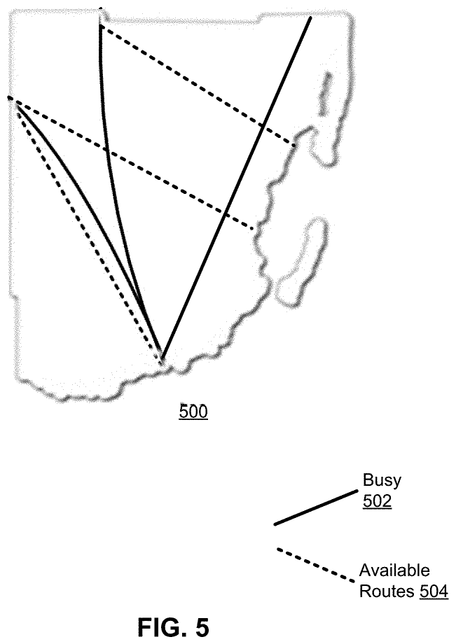

FIG. 5 is a diagrammatic illustration of delivery route across an exemplary geographic delivery area 500, consistent with the disclosed embodiments. As shown in FIG. 5, exemplary delivery area 500 is displayed as a portion of a particular geographic area. As shown in FIG. 5, delivery routes across this geographic area may be both busy 502 and available 504. As shown in FIG. 5, delivery routes may extend across a plurality of camps or from east to west across the geographic area to deliver supplies and other goods. Other geographic areas or camp areas may be contemplated. A first camp may be associated with a set of postal codes in proximity (e.g. a plurality of zip codes in a particular county or other subdivision); and an actual number of units sold may comprise a number of units associated with a plurality of camps. Alternatively, a camp may be associated with a set of postal codes (e.g. located in different counties or regions). Consistent with this disclosure, system 100 may generate forecast calculations to determine optimum delivery routes, and busy delivery routes 502 and available delivery routes 504 may fluctuate and change over time.

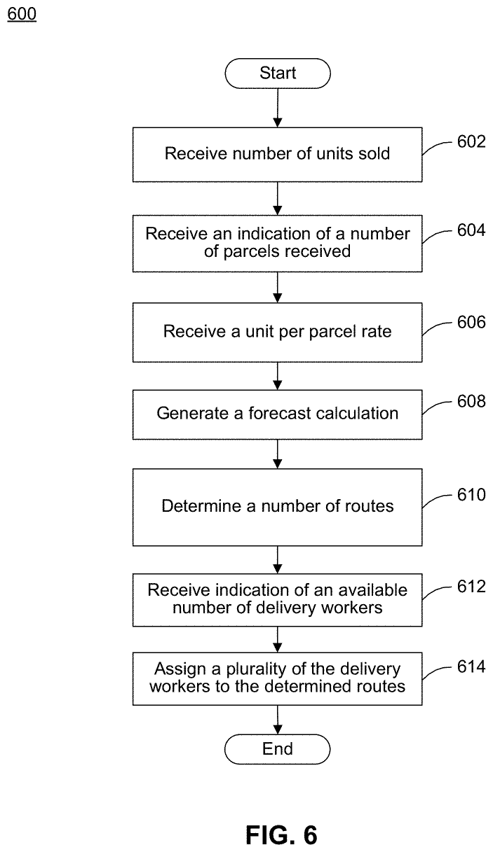

FIG. 6 is a flow chart illustrating an exemplary process for automatic delivery worker assignment, consistent with the disclosed embodiments. While the exemplary method 600 is described herein as a series of steps, it is to be understood that the order of the steps may vary in other implementations. In particular, steps may be performed in any order, or in parallel. Moreover, while shipment authority technology system (SAT) 101, transportation system 107, and/or shipment and order tracking (SOT) system 111 may perform the following steps, it is to be understood that systems 101, 107, and 111 may operate separately or may work together collectively in any manner to perform the following steps.

At step 602, shipment authority technology system (SAT) 101, transportation system 107, and/or shipment and order tracking (SOT) system 111 may receive an actual number of units sold during a first time period. An actual number of units sold may be representative of any product or item, consistent with this disclosure. Shipment authority technology system (SAT) 101, transportation system 107, and/or shipment and order tracking (SOT) system 111 may also determine a deliverable number of parcels based on the actual number of units sold and the unit per parcel rate; and may determine a number of routes based on the deliverable number of parcels. As shown in FIGS. 4 and 5, delivery routes may be confined to a particular camp or may extend over larger geographic delivery areas, such as a city or a portion of a state.

At step 604, shipment authority technology system (SAT) 101, transportation system 107, and/or shipment and order tracking (SOT) system 111 may receive an indication of a number of parcels received during a first period of time at a first camp. Consistent with disclosed embodiments, the received indication may also be received at Warehouse Management System 119 (WMS) and may include a text alert or notification message displayed via a graphical user interface (GUI). In some aspects, the received indication may also indicate a date and timestamp relating to receipt of parcels. In other aspects, the received indication may include a user query requesting confirmation that parcels were received.

At step 606, shipment authority technology system (SAT) 101, transportation system 107, and/or shipment and order tracking (SOT) system 111 may receive a unit per parcel rate associated with the first camp and may further divide the received number of units sold by the received number of parcels in order to calculate a unit per parcel rate. Shipment authority technology system (SAT) 101, transportation system 107, and/or shipment and order tracking (SOT) system 111 may also perform multiple calculations to determine multiple unit per parcel rate over different times or relating to different unit or product types. Systems 101, 107, and 111 may also determine a historical percentage of parcels for third-party delivery, may exclude the historical percentage of parcels from the deliverable number of parcels, and may determine a number of routes based on the deliverable number of parcels minus the excluded parcels, as part of its calculations. Other calculations may be contemplated. In some embodiments, the historical percentage of parcels for third-party delivery may be between 10 and 15 percent. Other historical percentages may be contemplated consistent with this disclosure.

At step 608, shipment authority technology system (SAT) 101, transportation system 107, and/or shipment and order tracking (SOT) system 111 may generate, based on the received actual number of units, the number of parcels received, and the unit per parcel rate, a forecast calculation for the first camp. The forecast calculation may include a first multiplication of a number of parcels received, by the unit per parcel rate to determine a forecast for an anticipated number of units that may be delivered relative to available parcels during a particular time period. The result of the first multiplication may then be compared to the received number of units sold to determine a forecast.

For example, in an exemplary embodiment, 500 units may be sold and a unit per parcel rate of 5 stock keeping units (SKUs)/1 parcel may be received. Unit per parcel rate may reflect how many items are included in each package (on average). These values may subsequently be multiplied by each other resulting in 100 parcels required for delivery. Subsequently, in other embodiments, systems 101, 107, and 111 may next compare a calculated or forecasted number of parcels (e.g. 100 parcels) to a received indication of a number of parcels received during an initial time period for a camp. Where the calculated or forecasted number of parcels (e.g. 100 parcels) exceeds the result of the indication of a number of parcels received during an initial time period for a camp, systems 101, 107, and 111 may only deliver the number of parcels received during the initial time period for a camp (e.g. since less than 100 parcels are available for delivery). Alternatively, where the calculated or forecasted number of parcels (e.g. 100 parcels) is determined as less than the result of the indication of a number of parcels received during an initial time period for a camp, systems 101, 107, and 111 may deliver the full calculated or forecasted number of parcels (e.g. 100 parcels) for the camp (e.g. since more than the required 100 parcels are available for delivery) s). Other forecast calculation methodologies comparing a received actual number of units, number of parcels received, and unit per parcel rate, may be contemplated.

Consistent with this disclosure, forecast calculation for the first camp may be further based on the camp-level capacity. Camp-level capacity may reflect an upper threshold amount of units that may be sold and delivered to a camp during an identified time period. Similarly, a first camp may be associated with a camp-level capacity. As shown in FIG. 3, the forecast calculation may further vary over time and based on the unit type. Further, a first camp may be associated with a first set of postal codes, and an actual number of units sold may comprise a number of units associated with a plurality of camps. While a forecast of the number of parcels may be generated based on three factors: units sold, units per parcel (e.g. how many boxes will be needed), and camp coverage (how many boxes arrived at a camp), additional factors may be included in the forecast calculation. For example, each camp team may further input a forecast value at a graphical user interface (GUI), and any of systems 101, 107, and 111 may receive volume related information. Other factors and other forecast calculation methodologies may be contemplated.

At step 610, shipment authority technology system (SAT) 101, transportation system 107, and/or shipment and order tracking (SOT) system 111 may determine, based on a forecast calculation, a number of routes, as shown in FIGS. 4-5. As shown in FIG. 4, both solid and dashed lines represent delivery routes available for a plurality of different delivery workers 402 based on a forecast calculation. As shown in FIG. 5, delivery routes may extend across a plurality of camps or larger geographic areas

At step 612, shipment authority technology system (SAT) 101, transportation system 107, and/or shipment and order tracking (SOT) system 111 may receive an indication of an available number of delivery workers. Consistent with disclosed embodiments, the received indication may include a text alert or notification message displayed via a graphical user interface (GUI). In some aspects, the received indication may also indicate a date and timestamp relating to receipt of an available number of delivery workers. In other aspects, the received indication may include a user query requesting confirmation or verification of the available number of delivery workers.

At step 614, shipment authority technology system (SAT) 101, transportation system 107, and/or shipment and order tracking (SOT) system 111 may assign a plurality of the delivery workers to the determined routes. System 100 may include assigning a plurality of the delivery workers to the determined routes including assigning the delivery workers based on individual target efficiency values for each delivery worker. In some embodiments, shipment authority technology system (SAT) 101, transportation system 107, and/or shipment and order tracking (SOT) system 111 may generate forecast calculations based on a received actual number of units, a first and a second number of parcels received, and a first and a second unit per parcel rate. In some embodiments, this may include a first forecast calculation for a first camp and a second forecast calculation for a second camp, wherein the first forecast calculation is different from the second forecast calculation, and may assign different routes based on the different forecast calculations.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computerized system for automatic delivery worker assignment, comprising:
at least one processor; and
at least one non-transitory storage medium comprising instructions that, when executed by the at least one processor, cause the at least one processor to perform steps comprising:
receiving an actual number of units sold during a first time period;
receiving an indication of a number of parcels received during a first period of time at a first camp;
determining a unit per parcel rate associated with the first camp based on the number of parcels received and the actual number of units sold during the first period of time at the first camp;
generating a forecast for a deliverable number of parcels, based on the received actual number of units, the number of parcels received, and the unit per parcel rate, for the first camp;
determining, based on the forecast, a number of routes;
receiving an indication of an available number of delivery workers;
assigning a plurality of the delivery workers to the determined routes; and
displaying via a user interface the number of parcels received, the forecast for the deliverable number of parcels, and the available number of delivery workers on devices operated by delivery workers.

2. The system of claim 1, wherein the steps further comprise:
determining the deliverable number of parcels based on the actual number of units sold and the unit per parcel rate; and
determining the number of routes based on the deliverable number of parcels.

3. The system of claim 2, wherein determining the number of routes further comprises:
determining a historical percentage of parcels for third-party delivery;
excluding the historical percentage of parcels from the deliverable number of parcels; and
determining the number of routes based on the deliverable number of parcels minus the excluded parcels.

4. The system of claim 3, wherein the historical percentage is between 10 and 15 percent.

5. The system of claim 1, wherein:
the first camp is associated with a set of postal codes; and
the actual number of units sold comprises a number of units associated with a plurality of camps.

6. The system of claim 1, wherein the first camp is associated with a camp-level capacity.

7. The system of claim 6, wherein the forecast for the first camp is further based on the camp-level capacity.

8. The system of claim 1, wherein assigning a plurality of the delivery workers to the determined routes comprises assigning the delivery workers based on individual target efficiency values for each delivery worker.

9. The system of claim 1, wherein the delivery workers comprise flex workers.

10. A computer-implemented method for automatic delivery worker assignment, the method comprising:
receiving an actual number of units sold during a first time period;
receiving an indication of a number of parcels received during a first period of time at a first camp;
determining a unit per parcel rate associated with the first camp based on the number of parcels received and the actual number of units sold during the first period of time at the first camp;
generating a forecast for a deliverable number of parcels, based on the received actual number of units, the number of parcels received, and the unit per parcel rate, for the first camp;
determining, based on the forecast, a number of routes;
receiving an indication of an available number of delivery workers;
assigning a plurality of the delivery workers to the determined routes; and
displaying via a user interface the number of parcels received, the forecast for the deliverable number of parcels, and the available number of delivery workers on devices operated by delivery workers.

11. The computer-implemented method of claim 10, the method further comprising:
determining the deliverable number of parcels based on the actual number of units sold and the unit per parcel rate; and
determining the number of routes based on the deliverable number of parcels.

12. The computer-implemented method of claim 11, the method further comprising:
determining a historical percentage of parcels for third-party delivery;
excluding the historical percentage of parcels from the deliverable number of parcels; and
determining the number of routes based on the deliverable number of parcels minus the excluded parcels.

13. The computer-implemented method of claim 12, wherein the historical percentage is between 10 and 15 percent.

14. The computer-implemented method of claim 10, wherein
the first camp is associated with a set of postal codes; and
the actual number of units sold comprises a number of units associated with a plurality of camps.

15. The computer-implemented method of claim 10, wherein the first camp is associated with a camp-level capacity.

16. The computer-implemented method of claim 15, wherein the forecast for the first camp is further based on the camp-level capacity.

17. The computer-implemented method of claim 10, wherein assigning a plurality of the delivery workers to the determined routes comprises assigning the delivery workers based on individual target efficiency values for each delivery worker.

18. The computer-implemented method of claim 10, wherein the delivery workers comprise flex workers.

19. A system comprising:
a memory storing instructions; and
at least one processor configured to execute the instructions to perform operations comprising:
receiving an actual number of units sold during first and second time periods;
receiving an indication of a first number of parcels received during a first period of time at a first camp;
receiving an indication of a second number of parcels received during a second period of time at a second camp;
determining a first unit per parcel rate associated with the first camp based on the number of parcels received and the actual number of units sold during the first period of time at the first camp and a second unit per parcel rate associated with the second camp based on the number of parcels received and the actual number of units sold during the second period of time at the second camp;
generating, based on the received actual number of units, the first and the second number of parcels received, and the first and second unit per parcel rate, a first forecast for a deliverable number of parcels for the first camp and a second forecast for a deliverable number of parcels for the second camp,
wherein the first forecast is different from the second forecast;
determining, based on the first forecast, a first number of routes;
determining, based on the second forecast, a second number of routes;
receiving an indication of an available number of delivery workers;
assigning a plurality of the delivery workers to the first and second determined routes; and
displaying via a user interface the first and the second number of parcels received, the first and the second forecast for the deliverable number of parcels, and the available number of delivery workers on devices operated by delivery workers.

20. The system of claim 19, wherein the delivery workers comprise flex workers.
